(19) United States
(12) Patent Application Publication
(10) Pub. No.: US 2019/0322838 A1
(43) Pub. Date: Oct. 24, 2019

(54) COMPOSITE MATERIAL

(71) Applicant: National University Corporation Nagoya University, Nagoya-shi (JP)

(72) Inventors: Koshi Takenaka, Nagoya-shi (JP); Yoshihiko Okamoto, Nagoya-shi (JP); Tsubasa Shinoda, Nagoya-shi (JP); Masaki Azuma, Tokyo (JP); Naruhiro Inoue, Nagoya-shi (JP)

(21) Appl. No.: 16/473,002

(22) PCT Filed: Dec. 22, 2017
(86) PCT No.: PCT/JP2017/046208

§ 371 Date: Jun. 24, 2019

(30) Foreign Application Priority Data
Dec. 27, 2016 (JP) 2016-254103

(51) Int. Cl. C08K 3/22; C01G 55/00

(52) U.S. Cl. CPC C08K 3/22; C08K 2003/2206; C01G 55/004

(57) ABSTRACT

A composite material of one aspect includes a resin matrix phase, and a ruthenium oxide having Ca₂RuO₄ structure and included in the resin matrix phase. The ruthenium oxide may be represented by a general formula (1): Ca₂₋ₓRₓRu_{1-y1}M_{y}O_{4+z}, in which R may represent at least one element selected from among alkaline earth metals and rare earth elements, M may represent at least one element selected from among Sc, Ti, V, Cr, Mn, Fe, Co, Ni, Cu, Zn, and Ga, and the values x, y, and z may satisfy 0≤x<0.2, 0≤y<0.3, and −1<z<−0.02.

### BACKGROUND OF THE INVENTION

### 1. Field of the Invention

The present invention relates to a composite material that includes a ruthenium oxide.

### 2. Description of the Related Art

It is known that, in general, substances thermally expand with increasing temperature. However, highly developed industrial technologies of recent years even require control of such thermal expansion, which is almost inevitable for solid materials. Even a variation of about 10 ppm (10⁻⁵) in length, generally regarded as a slight variation, could be a great problem in the field of semiconductor device manufacture in which high precision on the order of nanometers is required, or the field of precision equipment of which functions are largely affected by slight distortion of components, for example. Also, in devices formed of multiple materials in combination, other problems, such as interfacial peeling and disconnection, may be caused by differences in thermal expansion between the constituent materials.

Meanwhile, negative thermal expansion materials, having negative coefficients of thermal expansion, are also known, of which the lattice volumes decrease with increasing temperature. For example, a thermal expansion inhibitor that includes a perovskite manganese nitride crystal having a negative coefficient of thermal expansion has been devised (see Patent Document 1).

Also, it has been known that, when a ruthenium oxide with the chemical formula Ca₂RuO₄ having a layered perovskite crystal structure undergoes phase transition at about 90 degrees C. from a high-temperature metal (high-temperature L phase) to a low-temperature insulator (low-temperature S phase), the volume of the ruthenium oxide is larger in the low-temperature phase than in the high-temperature phase (Non-patent Documents 1-5).

### PRIOR ART REFERENCE

### Patent Document

[Patent Document 1] WO 06/011590

### Non-Patent Document

[Non-patent Document 1] S. Nakatsuji, S. Ikeda, and Y. Maeno, J. Phys. Soc. Jpn. 66, 1868-1871 (1997).

[Non-patent Document 2] M. Braden et al., Phys. Rev. B 58, 847-861 (1998).

[Non-patent Document 3] O. Friedt et al., Phys. Rev. B 63, 174432 (2001).

[Non-patent Document 4] T. F. Qi et al., Phys. Rev. Lett. 105, 177203 (2010).

[Non-patent Document 5] T. F. Qi et al., Phys. Rev. B 85, 165143 (2012).

Resin, aluminum, magnesium, or the like (hereinafter, also referred to as “resin or the like”, as appropriate) is widely used because of its lightness, excellent workability, and less expensiveness. Such resin or the like has a larger positive coefficient of thermal expansion, compared to other materials. Accordingly, by using resin or the like in combination with a negative thermal expansion material to form a composite material, thermal expansion of the composite material as a whole can be controlled.

However, since known negative thermal expansion materials have disadvantages of small degrees of negative thermal expansion and narrow operating temperature ranges for negative thermal expansion, for example, thermal expansion cannot be sufficiently restrained.

### SUMMARY OF THE INVENTION

The present disclosure has been made in view of such a situation, and one of the purposes thereof is to restrain thermal expansion of a composite material that includes resin or the like.

To solve the problem above, a composite material according to one aspect of the present disclosure includes a resin matrix phase, and a ruthenium oxide having Ca₂RuO₄ structure and included in the resin matrix phase.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram used to describe negative thermal expansion of a ruthenium oxide according to the present disclosure;

FIG. 2 is a diagram that shows relationships between temperature and linear thermal expansion of a specimen represented by the general formula Ca₂RuO_{4+z};

FIG. 3 is a diagram that shows relationships between temperature and linear thermal expansion of a specimen represented by the formula Ca₂Ru_{0.9}Mn_{0.1}O_{4+z};

FIG. 4 is a diagram that shows relationships between temperature and linear thermal expansion of a specimen represented by the formula Ca₂Ru_{0.92}Fe_{0.08}O_{4+z};

FIG. 5 is a diagram that shows relationships between temperature and linear thermal expansion of a specimen represented by the formula Ca₂Ru_{0.9}Cu_{0.1}O_{4+z};

FIG. 6 is a diagram that shows relationships between temperature and linear thermal expansion of specimens represented by the general formula Ca₂Ru_{1-y}Cr_{y}O_{4+z} with the value y changed (y=0.02, 0.05, 0.067, 0.1);

FIG. 7 is a diagram that shows relationships between temperature and linear thermal expansion of specimens represented by the general formula Ca₂₋ₓSrₓRuO_{4+z} with the value x changed (x=0.05, 0.1);

FIG. 8 is a diagram that shows relationships between temperature and linear thermal expansion of ruthenium oxides of Examples 1-1, 1-2, and Comparative Example 1;

FIG. 9 is a diagram that shows relationships between temperature and linear thermal expansion of composite material specimens, each prepared by mixing a ruthenium oxide with the formula Ca₂RuO_{0.92}Fe_{0.08}O_{3.82} and a predetermined amount of an epoxy resin (0, 45, 50, 65, 83, or 100 vol %);

FIG. 10 is a diagram that shows relationships between temperature and linear thermal expansion of composite material specimens, each prepared by mixing a ruthenium oxide with the formula Ca₂Ru_{0.9}MnO_{0.1}O_{3.73} or Ca₂RuO_{3.74} and a predetermined amount of an epoxy resin (61 vol % or 69 vol %);

FIG. 11 is a diagram that shows relationships between temperature and linear thermal expansion of composite material specimens, each prepared by mixing a ruthenium oxide with the formula Ca₂RuO_{0.9}Cu_{0.1}O_{3.82} or Ca₂Ru_{0.933}Cu_{0.067}O_{3.77} and a predetermined amount of an epoxy resin (48 vol % or 49 vol %);

FIG. 12 is a diagram that shows relationships between temperature and linear thermal expansion of composite material specimens, each prepared by mixing a ruthenium oxide with the formula Ca₂RuO_{3.74} or Ca₂Ru_{0.92}Fe_{0.08}O_{3.82} and a predetermined amount of PVB resin (29 vol % or 50 vol %) or a predetermined amount of a PAI resin (18 vol % or 32 vol %);

FIG. 13 is a diagram that shows relationships between temperature and linear thermal expansion of a composite material specimen prepared by mixing a ruthenium oxide with the formula Ca₂Ru_{0.92}Fe_{0.08}O_{3.82} and a predetermined amount of a phenolic resin (25 vol %);

FIG. 14 is a diagram that shows relationships between temperature and linear thermal expansion of specimens represented by the general formula Ca₂Ru_{1-y}Sn_{y}O_{4+z} with the value y changed (y=0.1, 0.3, 0.4);

FIG. 15 is a diagram that shows relationships between temperature and linear thermal expansion of a composite material specimen prepared by mixing a ruthenium oxide with the formula Ca₂Ru_{0.9}Sn_{0.1}O₄ and a predetermined amount of an epoxy resin (50 vol %); and

FIG. 16 is a diagram that shows relationships between temperature and linear thermal expansion of a composite material specimen prepared by mixing a ruthenium oxide with the formula Ca₂Ru_{0.9}Sn_{0.1}O₄ and a predetermined amount of aluminum (60 vol %).

### DETAILED DESCRIPTION OF THE INVENTION

As described previously, a ruthenium oxide is considered as a material that exhibits negative thermal expansion. For example, a precise structural analysis of Ca₂RuO₄ has shown that a temperature drop from 127 degrees C. to −173 degrees C. has caused expansion of about 1% as a total volume variation ΔV/V (Non-patent Document 3). The total volume variation ΔV/V is an amount derived from (Vmin−Vmax)/Vmax, wherein, when a temperature range in which negative thermal expansion is exhibited is defined as Tmin to Tmax, Vmin is the volume at Tmin, and Vmax is the volume at Tmax. With Ca₂Ru_{0.933}Cr_{0.67}O₄, obtained by replacing part of Ru with Cr, volume expansion of about 0.9% as the total ΔV/V caused by successive temperature drops has been reported (Non-patent Document 4), and, with Ca₂Ru_{0.90}MnO_{0.10}O₄, negative thermal expansion of −10×10⁻⁶/degree C. (about 0.8% as ΔV/V) in the temperature range of −143 to 127 degrees C. has been reported (Non-patent Document 5).

However, it cannot be said that such phenomena provide excellent functions as industrial thermal expansion inhibitors, for the reasons that the transition width during the sharp primary phase transition is generally narrow, such as 1 degree C. or less, and that large negative thermal expansion, such as expansion with the total volume variation of 1% or greater, cannot be seen, for example.

As a result of intensive study regarding compounds that exhibit negative thermal expansion, the inventors and others have found, surprisingly, that reductive heat treatment of Ca₂RuO₄ can achieve negative thermal expansion properties with a significantly large total volume variation ΔV/V. Further, the inventors and others have conceived that a combination of a ruthenium oxide exhibiting negative thermal expansion and a resin having a large positive coefficient of thermal expansion (linear expansion coefficient) can provide a composite material of which thermal expansion can be restrained. Specifically, this can be achieved by the following means described as examples.

A composite material according to one aspect of the present disclosure includes a resin matrix phase, and a ruthenium oxide having Ca₂RuO₄ structure and included in the resin matrix phase.

According to this aspect, by including a ruthenium oxide having Ca₂RuO₄ structure, which generally exhibits negative thermal expansion, in a resin matrix phase that exhibits positive thermal expansion, thermal expansion of the composite material caused by a temperature change can be restrained.

The resin matrix phase may include, as a material, one of epoxy resins, engineering plastics, polyvinyl butyral resin, and phenolic resins. Also, the resin matrix phase may include two or more kinds of the abovementioned materials. Alternatively, the resin matrix phase may include a resin other than the abovementioned materials. Alternatively, the resin matrix phase may include a material other than resins, such as a metal and ceramic. Accordingly, a volume change of the composite material caused by a temperature change can be adjusted depending on the use.

The linear expansion coefficient of the resin may be 2×10⁻⁵/degree C. or greater. Even though the resin as a material has a relatively large positive linear expansion coefficient, by using such a resin in combination with a ruthenium oxide having Ca₂RuO₄ structure to form a composite material, thermal expansion thereof can be restrained.

The ruthenium oxide may be represented by a general formula (1): Ca₂₋ₓRₓRu_{1-y}M_{y}O_{4+z}, wherein R may represent at least one element selected from among alkaline earth metals and rare earth elements; M may represent at least one element selected from among Sc, Ti, V, Cr, Mn, Fe, Co, Ni, Cu, Zn, and Ga; and the values x, y, and z may satisfy 0≤x<0.2, 0≤y<0.3, and −1<z<−0.02.

The ruthenium oxide may be represented by a general formula (2): Ca₂₋ₓRₓRu_{1-y}M_{y}O_{4+z}, wherein R may represent at least one element selected from among alkaline earth metals and rare earth elements; M may represent at least one element selected from among Sc, Ti, V, Cr, Mn, Fe, Co, Ni, Cu, Zn, and Ga; and the values x, y, and z may satisfy 0≤x<0.2, 0≤y<0.3, and −1<z<1.

Also, the ruthenium oxide may exhibit negative thermal expansion throughout the range of a temperature Tmin to a temperature Tmax (Tmin<Tmax), and a total volume variation ΔV/V, which is an increase rate of the volume at the temperature Tmin based on the volume at the temperature Tmax, may be larger than 1%.

In the general formula (1) or (2), R may represent at least one of the elements Sr, Ba, Y, La, Ce, Pr, Nd, and Sm, and M may represent at least one of the elements Ti, V, Cr, Mn, Fe, Co, Ni, Cu, and Zn. Further, in the general formula (1) or (2), R may represent at least one of the elements Sr and Ba, and M may represent at least one of the elements Cr, Mn, Fe, and Cu. Also, in the general formula (1) or (2), the values x and y may satisfy x=y=0.

The ruthenium oxide may exhibit negative thermal expansion in a predetermined temperature range and may be represented by a general formula (3): Ca₂RuO_{4+z}, wherein the value z may satisfy −1<z<1.

The ruthenium oxide may have a linear expansion coefficient of −20×10⁻⁶/degree C. or less. Accordingly, the ruthenium oxide exhibits a large degree of negative thermal expansion and hence is highly available in industrial fields. For a similar reason, the ruthenium oxide may exhibit negative thermal expansion throughout a temperature range having a width of 100 degrees C. or more.

The ruthenium oxide may have a layered perovskite crystal structure. Also, the crystal system of the ruthenium oxide may be the rhombic system.

Another aspect of the present disclosure is a thermal expansion inhibitor. The thermal expansion inhibitor may include the ruthenium oxide described above. Similarly, yet another aspect of the present disclosure is a negative thermal expansion material. The negative thermal expansion material may include the ruthenium oxide described above. Similarly, still yet another aspect of the present disclosure is a zero thermal expansion material. The zero thermal expansion material may include the ruthenium oxide described above. Similarly, still yet another aspect of the present disclosure is a low thermal expansion material. The low thermal expansion material may include the ruthenium oxide described above.

A further aspect of the present disclosure is a method for producing a composite material including a resin and a ruthenium oxide. The method includes a reductive heat treatment process in which heat treatment is performed on a ruthenium oxide represented by a general formula (4) as provided below, under an oxygen-containing atmosphere with the oxygen partial pressure of 0.3 atmospheres or less, at a temperature higher than 1,100 degrees C. and lower than 1,400 degrees C.

Ca₂₋ₓRₓRu_{1-y}M_{y}O_{4+z} General formula (4):

(wherein R represents at least one element selected from among alkaline earth metals and rare earth elements; M represents at least one element selected from among Sc, Ti, V, Cr, Mn, Fe, Co, Ni, Cu, Zn, and Ga; and the values x, y, and z satisfy 0≤x<0.2, 0≤y<0.3, and −1<z<1)

The ruthenium oxide represented by the general formula (4) may be prepared in a calcination process in a solid-phase reaction method, and the calcination process may preferably be performed also as the reductive heat treatment process. Accordingly, the production process can be simplified.

In the general formula (4), R may represent at least one of the elements Sr, Ba, Y, La, Ce, Pr, Nd, and Sm, and M may represent at least one of the elements Ti, V, Cr, Mn, Fe, Co, Ni, Cu, and Zn. Further, in the general formula (4), R may represent at least one of the elements Sr and Ba, and M may represent at least one of the elements Cr, Mn, Fe, and Cu. Also, in the general formula (4), the values x and y may satisfy x=y=0.

As described above, the ruthenium oxides of the present disclosure are new substances discovered by the inventors and others. With the ruthenium oxides included in the composite materials of the present disclosure, the following effects can be obtained.

Firstly, the present disclosure provides ruthenium oxides that exhibit negative thermal expansion of which the total volume variations are larger than those of conventional ruthenium oxides. With regard to conventionally-known ruthenium oxides that exhibit negative thermal expansion, the total volume variations thereof are at most 1% and none of them exceed 1%; on the other hand, the present disclosure can provide ruthenium oxides of which the total volume variations exceed 1%, and a total volume variation of 6% or more can also be achieved, for example. Also, the linear expansion coefficients of the ruthenium oxides of the present disclosure can be made less than −20×10⁻⁶/degree C., and a linear expansion coefficient of less than −100×10⁻⁶/degree C. can also be achieved, for example. Accordingly, the ruthenium oxides can be widely used as industrial thermal expansion inhibitors. Particularly, even with a material that exhibits large thermal expansion, such as a resin and an organic substance, thermal expansion can be restrained.

Secondly, the ruthenium oxides of the present disclosure exhibit negative thermal expansion in significantly wide temperature ranges. For example, throughout a wide temperature range having a width of 400 degrees C. or more, negative thermal expansion with a linear expansion coefficient of less than −20×10⁻⁶/degree C. can be exhibited. Particularly, by replacing part of Ru sites with Sn, negative thermal expansion can be exhibited throughout a wider temperature range (with a width of 500 degrees C. or more, for example), and the maximum temperature Tmax for negative thermal expansion can be further raised. Accordingly, even with a material that could be heated to 200 degrees C. or higher, for example, thermal expansion can be restrained. Therefore, by selecting an appropriate thermal expansion inhibitor, thermal expansion of a member used in a high-temperature environment or a device in which multiple components are bonded can also be adjusted. Also, even with a material that could be cooled to −100 degrees C. or lower, thermal expansion can be restrained. Therefore, thermal expansion of a refrigerator component or the like can be adjusted.

Thirdly, the ruthenium oxides of the present disclosure can be used in the form of powder. Accordingly, like ceramics, the ruthenium oxides can be fired and hardened into any shapes. Also, the ruthenium oxides can be easily mixed with a raw material of the matrix phase, such as resin or the like.

Fourthly, the ruthenium oxides of the present disclosure can be formed of environment-friendly materials and hence are preferable also in environmental aspects. Also, since part of Ru sites can be replaced with less expensive Sn, cost reduction can be achieved.

In the following, modes for carrying out the present disclosure will be described in detail with reference to the drawings or the likes.

### [Structure of Ruthenium Oxides]

Each ruthenium oxide of the present disclosure is represented by the general formula Ca₂₋ₓRₓRu_{1-y}M_{y}O_{4+z}, which is a new substance that exhibits negative thermal expansion and is defined by at least one of the properties of the oxygen content z (the value z in the general formula) and the total volume variation ΔV/V (of which the definition will be described later). In the general formula, R represents at least one element selected from among alkaline earth metals and rare earth elements, and M represents at least one element selected from among Sc, Ti, V, Cr, Mn, Fe, Co, Ni, Cu, Zn, and Ga. Also, the values x and y satisfy 0≤x<0.2 and 0≤y<0.3.

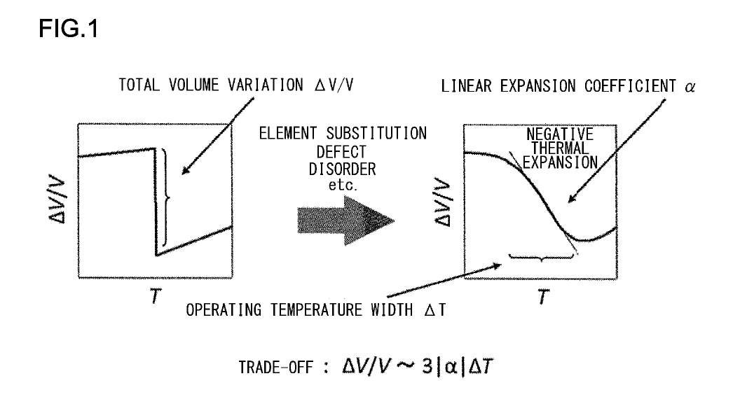

FIG. 1 is a diagram used to describe negative thermal expansion of a ruthenium oxide according to the present disclosure. Each ruthenium oxide of the present disclosure is a Mott insulator that exhibits metal-insulator transition, and negative thermal expansion of the ruthenium oxide is phase-transition negative thermal expansion achieved by successive volume changes caused by the phase transition in relation to temperature.

Each ruthenium oxide of the present disclosure may preferably have a layered perovskite crystal structure. The crystal structure may be one of the rhombic system (orthorhombic system), tetragonal system, monoclinic system, and trigonal system, but the rhombic system may be preferable.

It is to be understood that variations in proportion of constituting elements may be made within the scope of general assumption and without departing from the spirit of the present disclosure and that ruthenium oxides with such variations are also included in the scope of the present disclosure. For example, with regard to Ca₂RuO_{3.9}, even if the ratio Ca:Ru is 2.01:0.99, such a ruthenium oxide is also included in the scope of the present disclosure.

### [R in General Formulae]

In the general formulae, R may be at least one element selected from among alkaline earth metals and rare earth elements. By selecting the type of the element R and the R content x (the value x in the general formulae), the temperature range for negative thermal expansion, the total volume variation ΔV/V, and the thermal expansion coefficient can be controlled. Preferably, R may be at least one of the elements Sr, Ba, Y, La, Ce, Pr, Nd, and Sm. More preferably, R may be at least one of the elements Sr and Ba, and further preferably be Sr. Based on general knowledge of oxide synthesis, it can be predicted that, if Ca₂₋ₓ SrₓRuO_{4+z} can be prepared as described in Examples, for example, multiple other alkaline earth elements and rare earth elements having similar chemical properties, such as Ba, will also easily form solid solution in Ca sites. The gist of the present disclosure resides in controlling the total volume variation and the operating temperature range for negative thermal expansion by replacing Ca sites with other metal species, so that R is not limited to one element.

The R content x satisfies 0≤x<0.2. Within the range, a large degree of negative thermal expansion can be induced, and the temperature range for negative thermal expansion, the total volume variation ΔV/V, and the thermal expansion coefficient can be controlled within ranges appropriate for industrial applications, such as applications to thermal expansion inhibitors. The R content x may more desirably satisfy 0≤x≤0.15, further desirably satisfy 0≤x≤0.1, and most desirably satisfy 0≤x≤0.07.

### [M in General Formulae]

In the general formulae, M may be at least one element selected from among Sc, Ti, V, Cr, Mn, Fe, Co, Ni, Cu, Zn, and Ga. By selecting the type of the element M and the M content y (the value y in the general formulae), the temperature range for negative thermal expansion, the total volume variation ΔV/V, and the thermal expansion coefficient can be controlled. Preferably, M may be at least one of the elements Ti, V, Cr, Mn, Fe, Co, Ni, Cu, and Zn, and more preferably be at least one of the elements Cr, Mn, Fe, and Cu. Based on general knowledge of oxide synthesis, it can be predicted that, if Ca₂Ru_{1-y}Cr_{y}O_{4+z} and Ca₂Ru_{1-y}MnO_{4+z} can be prepared as described in Examples, for example, Ca₂Ru_{1-y1-y2}Cr_{y1}Mn_{y2}O_{4+z} can be easily synthesized; it can also be predicted that, if Cr, Mn, Fe, or Cu can be used as M in Examples, multiple other transition metals having similar chemical properties, such as Ti, will also easily form solid solution in Ru sites. The gist of the present disclosure resides in controlling, for example, the total volume variation and the operating temperature range for negative thermal expansion by replacing Ru sites with other metal species, so that M is not limited to one element.

The M content y satisfies 0≤y<0.3. Within the range, a large degree of negative thermal expansion can be induced, and the temperature range for negative thermal expansion, the total volume variation ΔV/V, and the thermal expansion coefficient can be controlled within ranges appropriate for industrial applications, such as applications to thermal expansion inhibitors. The M content y may more desirably satisfy 0≤y≤0.2, further desirably satisfy 0≤y≤0.13, and most desirably satisfy 0≤y≤0.1.

[Oxygen Content z]

Each ruthenium oxide of the present disclosure is defined by the oxygen content z, which satisfies −1<z<−0.02. It has been reported that “oxygen excess (z>0) can be achieved, but oxygen deficiency (z<0) is not easy to achieve” {F. Nakamura, et al., Sci. Rep. 3, 2536 (2013), for example}, which has been general recognition before the filing of the subject application. Thus, a ruthenium oxide of which the oxygen content z satisfies −1<z<−0.02 has been unknown and hence is a new substance. By setting the oxygen content z within the abovementioned range, a ruthenium oxide that exhibits negative thermal expansion with a large total volume variation ΔV/V can be provided. Also, negative thermal expansion can be exhibited in a wide temperature range, and a large negative linear expansion coefficient can be achieved. The range of the oxygen content z may desirably be −0.5<z<−0.02, more desirably be −0.4<z<−0.03, further desirably be −0.4<z<−0.05, and most desirably be −0.35<z<−0.05.

In general, evaluating the oxygen contents in oxides is technically difficult, and, even when an oxygen content can be measured, the value may include an experimental error. Accordingly, there may be a case where the oxygen content z of a ruthenium oxide cannot be sufficiently evaluated. Even in such a case, however, each ruthenium oxide of the present disclosure can be defined by the total volume variation ΔV/V.

When a ruthenium oxide of the present disclosure is defined by a factor other than the oxygen content z, i.e., by the total volume variation ΔV/V, the oxygen content z may be a value that satisfies −1<z<1. The oxygen content z may desirably satisfy −0.5<z<0.2, more desirably satisfy −0.4<z<0.1, further desirably satisfy −0.35<z<0.05, and most desirably satisfy −0.3<z<0.01.

### [Another Ruthenium Oxide of Present Disclosure]

Another ruthenium oxide of the present disclosure is represented by the general formula Ca₂₋ₓRₓRu_{1-y1-y2}Sn_{y1}M_{y2}O_{4+z}, which is a substance defined by an Sn content y1 (the value y1 in the general formula) and exhibits negative thermal expansion. In the general formula, R and M are elements similar to those as described previously. More specifically, R is at least one element selected from among alkaline earth metals and rare earth elements, and M is at least one element selected from among Sc, Ti, V, Cr, Mn, Fe, Co, Ni, Cu, Zn, Ga, Y, Zr, Nb, Mo, Tc, Ru, Rh, Pd, Ag, Cd, and In. Also, the values x, y1, y2, and z satisfy 0≤x<0.2, 0<y1<0.5, 0≤y2≤0.2, 0<y1+y2≤0.6, and −1<z<1. Although the another ruthenium oxide of the present disclosure can be defined by the Sn content y1 without using the oxygen content z or the total volume variation ΔV/V, defining the ruthenium oxide using the oxygen content z or the total volume variation ΔV/V in addition to the Sn content y1 is not inhibited.

In the another ruthenium oxide of the present disclosure, the range of the R content x is the same as described previously, i.e., 0≤x<0.2, and the range may more desirably be 0≤x≤0.15, further desirably be 0≤x≤0.1, and most desirably be 0≤x≤0.07. As a matter of course, x may be set to zero.

In the another ruthenium oxide of the present disclosure, the Sn content y1 satisfies 0<y1<0.5. As clarified in the present disclosure, within this range, a large degree of negative thermal expansion can be induced, and the temperature range for negative thermal expansion, the total volume variation ΔV/V, and the thermal expansion coefficient can be controlled within ranges appropriate for industrial applications, such as applications to thermal expansion inhibitors. Also, since Sn is less expensive than Ru and since the another ruthenium oxide of the present disclosure exhibits negative thermal expansion even when part of Ru sites are replaced with Sn in large proportion, the ruthenium oxide has a great industrial advantage of providing a less expensive negative thermal expansion material. Also, replacing Ru sites with Sn can widen the temperature range for negative thermal expansion and can particularly raise the maximum temperature Tmax for negative thermal expansion. The range of y1 may more desirably be 0<y1≤0.45, further desirably be 0<y1≤0.4, and most desirably be 0<y1≤0.3.

In the another ruthenium oxide of the present disclosure, the sum of the Sn content y1 and the M content y2, i.e., y1+y2, satisfies 0<y1+y2≤0.6. Within the range, a large degree of negative thermal expansion can be induced, and the temperature range for negative thermal expansion, the total volume variation ΔV/V, and the thermal expansion coefficient can be controlled within ranges appropriate for industrial applications, such as applications to thermal expansion inhibitors. The sum y1+y2 may more desirably satisfy 0<y1+y2≤0.5, further desirably satisfy 0<y1+y2≤0.4, and most desirably satisfy 0<y1+y2≤0.35. Besides the sum y1+y2, the M content y2 solely has a desirable range of 0≤y2≤0.2. The M content y2 may more desirably satisfy 0≤y2≤0.13, and most desirably satisfy 0≤y2≤0.1. As a matter of course, y2 may be set to zero.

### [Total Volume Variation ΔV/V]

The total volume variation ΔV/V is an amount as defined below. The temperature range in which negative thermal expansion is exhibited is defined as Tmin to Tmax (Tmin<Tmax), and the volumes at Tmin and Tmax are respectively defined as Vmin and Vmax. In other words, Tmin is the minimum temperature for negative thermal expansion, and Tmax is the maximum temperature for negative thermal expansion. The total volume variation ΔV/V is an amount derived from (Vmin−Vmax)/Vmax (see FIG. 1). The total volume variation ΔV/V is an index used to evaluate the degree of negative thermal expansion. The reasons for using such an amount to evaluate the degree of negative thermal expansion will be described below.

The negative thermal expansion exhibited by the ruthenium oxides of the present disclosure is “phase-transition” negative thermal expansion achieved by successive volume changes caused by phase transition in relation to temperature, with element substitution, crystal defect, disordered crystal structure, or the like introduced thereto (see FIG. 1). In such phase-transition negative thermal expansion, the slope a of linear thermal expansion, the operating temperature width ΔT, and the total volume variation ΔV/V roughly satisfy the relation ΔV/V˜3|α|ΔT (which does not strictly hold because a is not necessarily constant within the temperature range for negative thermal expansion). The linear expansion coefficient is a coefficient of linear thermal expansion exhibited by an isotropic substance or by a polycrystalline body obtained by sintering powder crystal, and it is assumed that the linear expansion coefficient α and a volumetric expansion coefficient β, which is related to volumetric thermal expansion, satisfy the relation α=(1/3)β. Thus, the degree of negative thermal expansion and the operating temperature width have a trade-off relationship, so that, generally, a wider operating temperature width leads to a smaller negative slope, and a larger negative slope leads to a narrower operating temperature width. Accordingly, for such a phase-transition negative thermal expansion material, besides the linear expansion coefficient α, the total volume variation ΔV/V also needs to be used as an index to evaluate the capability of restraining thermal expansion (the degree of negative thermal expansion).

Each ruthenium oxide of the present disclosure is defined by the total volume variation ΔV/V, which is larger than 1%. A ruthenium oxide that shows such a large total volume variation ΔV/V has been unknown and hence is a new substance. The reason why the ruthenium oxide shows a larger total volume variation ΔV/V, compared to conventional ruthenium oxides, remains unclear. The crystal defect caused by lack of oxygen may have an influence thereon, but the possibility of another cause cannot be denied.

In terms of industrial applications as thermal expansion inhibitors, larger total volume variations ΔV/V are more preferable; accordingly, the total volume variation ΔV/V may preferably be 2% or greater, more preferably be 3% or greater, further preferably be 4% or greater, and most preferably be 6% or greater. The upper limit of the total volume variation ΔV/V is not particularly set, and the total volume variation ΔV/V may be within a range assumed for general substances. However, if the total volume variation ΔV/V is extremely large, the crystal structure may become unstable, so that the total volume variation ΔV/V may preferably be set to 30% or less, more preferably to 20% or less, and further preferably to 16% or less.

### [Linear Expansion Coefficient]

As thermal expansion of solid materials, linear thermal expansion is generally evaluated. The linear thermal expansion at a temperature T is defined as (L(T)−L0)/L0=ΔL/L0, wherein L(T) is the length of a specimen at the temperature T, and L0 is the length of the specimen at a reference temperature. In the case of an isotropic substance having no anisotropy in crystal orientation or of a polycrystalline body obtained by sintering powder crystal, the linear thermal expansion and volumetric thermal expansion, which is an index of a volume change in relation to temperature and defined as (V(T)−V0)/V0=ΔV/V0 (V is volume), satisfies the relation ΔL/L0=(1/3)ΔV/V0. Each ruthenium oxide of the present disclosure is generally a rhombic crystal, and the physical properties, including thermal expansion, thereof depend on crystal orientation. In each of Examples and Comparative Example of the subject application, a polycrystalline body obtained by sintering powder crystal is used for measurement, so that the crystal orientation dependence of the resultant linear thermal expansion is averaged, and the linear thermal expansion is equal to a third of the volumetric thermal expansion.

The linear expansion coefficient α is a temperature differential of linear thermal expansion and is defined as α=d(ΔL/L0)/dT. Similarly, the volumetric expansion coefficient β is defined as β=d(ΔV/V0)/dT. In the case of an isotropic substance or a polycrystalline body obtained by sintering powder crystal, the relation α=(1/3)β is satisfied, which also holds in the subject application.

Each ruthenium oxide of the present disclosure may desirably have the linear expansion coefficient α of −20×10⁻⁶/degree C. or less. The linear expansion coefficient α as used herein means an average value of the linear expansion coefficients α within the temperature range in which negative thermal expansion is exhibited. With the linear expansion coefficient α less than −20×10⁻⁶/degree C., the ruthenium oxides of the present disclosure can be used in a wide range of industrial fields and are highly available as thermal expansion inhibitors or the likes. The linear expansion coefficient α may more desirably be −30×10⁻⁶/degree C. or less, and further desirably be −60×10⁻⁶/degree C. or less. Generally, with regard to phase-transition negative thermal expansion materials, such as the ruthenium oxides of the present disclosure, when the linear expansion coefficient α is smaller (i.e., the absolute value of the negative value is larger), the temperature range for negative thermal expansion becomes narrower, and the linear expansion coefficient α can be decreased without limit. Although the lower limit of the linear expansion coefficient α is not particularly limited, it is noted that there may be a case where the lower limit is set in relation to the desired temperature range for negative thermal expansion.

### [Temperature Range for Negative Thermal Expansion]

Each ruthenium oxide of the present disclosure exhibits large negative thermal expansion in a significantly wide temperature range. In terms of applicability in a wide range of industrial fields, the temperature range for negative thermal expansion may desirably have a width of 100 degrees C. or more. By selecting an appropriate ruthenium oxide of the present disclosure, thermal expansion of a member used in a high-temperature environment, a device in which multiple components are bonded, or a composite material containing a resin can also be adjusted. Also, even with a material that could be cooled to −100 degrees C. or lower, thermal expansion can be restrained; accordingly, thermal expansion of refrigerator components, for example, can also be adjusted. In such a temperature range, the ruthenium oxide can exhibit large negative thermal expansion with the linear expansion coefficient of −20×10⁻⁶/degree C. or less. Also, although the temperature range for negative thermal expansion of each ruthenium oxide of the present disclosure generally includes room temperature (27 degrees C.), the upper limit of the temperature range can be set to room temperature or lower by controlling the R content x and the M content y. Particularly, by replacing part of Ru sites with Sn, negative thermal expansion can be exhibited in a wider temperature range, and the maximum temperature Tmax for negative thermal expansion can be further raised.

The width of the temperature range in which negative thermal expansion is exhibited (the width corresponds to Tmax-Tmin, wherein Tmax>Tmin) may more desirably be 200 degrees C. or more, further desirably be 300 degrees C. or more, and most desirably be 400 degrees C. or more. There is no particular upper limit in the width of the temperature range for negative thermal expansion. However, as described previously, since each ruthenium oxide of the present disclosure is a phase-transition negative thermal expansion material, the negative linear expansion coefficient and the temperature range for negative thermal expansion have a trade-off relationship. Accordingly, if the temperature range for negative thermal expansion is too wide, the linear expansion coefficient will be increased (the absolute value of the negative linear expansion coefficient will be decreased). Therefore, the width of the temperature range for negative thermal expansion may desirably be set to 1000 degrees C. or less, more desirably to 800 degrees C. or less, and further desirably to 700 degrees C. or less.

### [Specific Examples of Ruthenium Oxides of Present Disclosure]

In the following, specific general formulae suitable for the ruthenium oxides of the present disclosure will be given. Obviously, the present disclosure is not limited thereto.

For example, the ruthenium oxides of the present disclosure may be compounds with the formulae Ca₂RuO_{3.7-3.979}, Ca₂Ru_{0.85-0.95}Mn_{0.05-0.15}O_{3.7-3.979}, Ca₂Ru_{0.87-0.97}Fe_{0.03-0.13}O_{3.7-3.979}, Ca₂Ru_{0.85-0.95}Cu_{0.05-0.15}O_{3.7-3.979}, Ca₂Ru_{0.8-1.0}Cr_{0-0.2}O_{3.7-3.979}, Ca_{1.85-2}Sr_{0-0.15}RuO_{3.7-3.979}, and Ca₂Ru_{0.55-0.97}Sn_{0.03-0.45}O_{3.7-4.05}.

### [Production Method]

The ruthenium oxides of the present disclosure can be obtained by performing “reductive heat treatment” on ruthenium oxides prepared by conventional methods. The reductive heat treatment as used herein means heat treatment performed under an oxygen-containing atmosphere with the oxygen partial pressure of 0.3 atmospheres or less, at a temperature higher than 1,100 degrees C. and lower than 1,400 degrees C. Although the reason why such reductive heat treatment enables negative thermal expansion larger than that of conventional ruthenium oxides is unclear, it is considered that the reductive heat treatment acts such that oxygen defects from the crystal, causing crystal defect, which may be associated with the large negative thermal expansion. Nevertheless, possibilities of other causes are not eliminated.

In the reductive heat treatment, the oxygen partial pressure may be 0.3 atmospheres or less, more desirably be 0.25 atmospheres or less, and further desirably be 0.22 atmospheres or less. Also, the oxygen partial pressure may desirably be 0.05 atmospheres or higher, more desirably be 0.1 atmospheres or higher, and further desirably be 0.15 atmospheres or higher. Although the total pressure is not particularly specified as long as the oxygen partial pressure falls within the abovementioned range, the total pressure may preferably be set within the range of 0.5 to 2.0 atmospheres in terms of ease of preparation, for example. Also, a gas, besides oxygen, included in the atmosphere may desirably be an inert gas, such as nitrogen and a noble gas. For example, air or argon-oxygen mixed gas may be used as the atmosphere for the reductive heat treatment of the present disclosure.

A ruthenium oxide to be subjected to the reductive heat treatment may be prepared by a conventionally-known method. For example, the method may be a solid-phase reaction method, liquid-phase growth method, melt growth method, vapor-phase growth method, or vacuum film formation method. The vacuum film formation method may be, for example, molecular beam epitaxy (MBE), laser ablation, or sputtering. Among the abovementioned methods, a solid-phase reaction method may be preferably used for the ruthenium oxide preparation in terms of industrial mass production. When the ruthenium oxide is prepared using a solid-phase reaction method, heat treatment for calcination during the method may be performed also as the reductive heat treatment. Accordingly, the production process can be simplified. A material used in the solid-phase reaction method may be mixed powder obtained by mixing, at a predetermined mole ratio, powder of an oxide or carbonate of R (R is the same element as defined in the general formulae of the ruthenium oxides of the present disclosure), such as CaCO₃ and La₂O₃, RuO₂ powder, powder of an oxide of M (M is the same element as defined in the general formulae of the ruthenium oxides of the present disclosure), such as Cr₂O₃, and powder of an oxide of Sn, such as SnO₂.

In the reductive heat treatment, the temperature may be higher than 1,100 degrees C. and lower than 1,400 degrees C. A temperature equal to or higher than 1,400 degrees C. may be undesirable as a ruthenium oxide of another phase, such as CaRuO₃, may be produced. A temperature equal to or lower than 1,100 degrees C. may also be undesirable as the reaction may not sufficiently proceed, so that large negative thermal expansion may not be exhibited. The temperature may more desirably be higher than 1,200 degrees C. and lower than 1,390 degrees C., and further desirably be higher than 1,250 degrees C. and lower than 1,380 degrees C.

### [Thermal Expansion Inhibitor]

The ruthenium oxides of the present disclosure can be used as thermal expansion inhibitors for cancelling and restraining thermal expansion of materials that exhibit positive thermal expansion. For example, by including a ruthenium oxide of the present disclosure in a resin matrix phase, a composite material of which thermal expansion is restrained can be obtained.

### [Negative Thermal Expansion Material, Low Thermal Expansion Material, and Zero Thermal Expansion Material]

By using a ruthenium oxide of the present disclosure as a thermal expansion inhibitor by, for example, mixing the ruthenium oxide in a material that exhibits positive thermal expansion (such as a resin), a negative thermal expansion material that exhibits negative thermal expansion within a specific temperature range can be prepared. Similarly, a zero thermal expansion material, which exhibits neither positive nor negative thermal expansion within a specific temperature range, can also be prepared. Similarly, a low thermal expansion material, which has a linear expansion coefficient decreased to a predetermined positive value, can also be prepared by adding a ruthenium oxide of the present disclosure to a material that exhibits large positive thermal expansion. For example, quartz SiO₂ (α is about 0.5×10⁻⁶/degree C.), silicon Si (α is about 3×10⁻⁶/degree C.), or silicon carbide SiC (α is about 5×10⁻⁶/degree C.) is known as a low thermal expansion material. The low thermal expansion in the present disclosure means the level of thermal expansion of the abovementioned materials or below.

When a negative thermal expansion material, a low thermal expansion material, or a zero thermal expansion material is prepared using a ruthenium oxide of the present disclosure, the type of the base material used therein is not particularly specified as long as it does not depart from the spirit of the present disclosure, and a wide range of publicly-known materials, such as glass, resins, ceramics, metals, and alloys, can be applied. Particularly, since each ruthenium oxide of the present disclosure can be used in the form of powder, the ruthenium oxide can be preferably used with a material that can be fired and hardened into any shape, such as a ceramic. Also, such a ruthenium oxide can be evenly dispersed in a resin matrix phase more easily.

In the following, specific examples of the present disclosure will be described with reference to the drawings but should not be construed as limiting the present disclosure. The materials, amounts used, proportion, processes, and procedures described in the following examples may be appropriately changed without departing from the spirit of the present disclosure.

### EXAMPLES

### Examples 1

### (1) Preparation of Ruthenium Oxides

Using powders of CaCO₃, RuO₂, Cr₂O₃, Mn₃O₄, Fe₃O₄, and CuO as materials, a ruthenium oxide represented by Ca₂Ru_{1-y}M_{y}O_{4+z} (M is Cr, Mn, Fe, or Cu; the same applies hereinafter) was obtained by a solid-phase reaction method. First, the material powders were weighed out such that the mole ratio of Ca:Ru:M became 2:1-y:y and agitated, and the resultant mixture was then heated and calcined in the air or in a stream of mixed gas containing 0.8 atmospheres of argon and 0.2 atmospheres of oxygen, at a temperature in the range of 1,000 to 1,100 degrees C. for 12 to 24 hours.

The resultant powder was agitated and packed into a tablet form, and then heated and calcined in a stream of mixed gas containing 0.8 atmospheres of argon and 0.2 atmospheres of oxygen, at a temperature in the range of 1,250 to 1,370 degrees C. for 40 to 60 hours to be sintered, thereby obtaining a ruthenium oxide represented by the general formula Ca₂Ru_{1-y}M_{y}O_{4+z}. Such heat treatment will be hereinafter referred to as “reductive heat treatment”.

Also, a ruthenium oxide obtained by replacing part of Ca with Sr in Ca₂Ru_{1-y}M_{y}O_{4+z} was prepared according to the method set forth above, in which a predetermined mole fraction of CaCO₃ in the starting materials was replaced with SrCO₃.

In the specimen preparation described above, each material was powder with the purity of 99.9% or higher and having a particle size of 1 to 50 μm. Each of the prepared specimens was evaluated by powder X-ray diffraction (Debye-Scherrer method), and it was ascertained that the specimen was single-phase and a rhombic crystal at room temperature.

Meanwhile, calcination was also performed in a condition where the temperature in the heating and calcination was set to 1,400 degrees C., for example; however, in this case, a single-phase specimen could not be obtained because a ruthenium oxide of another phase, such as CaRuO₃, was produced, for example. Similarly, calcination was also performed at 1,100 degrees C., for example, but yet a single-phase specimen could not be obtained because part of the material powders remained unreacted, for example.

### (2) Linear Thermal Expansion of Ruthenium Oxides

With regard to each specimen of Example 1-1 prepared as described above, the total volume variation ΔV/V, linear expansion coefficient α, temperature range ΔT for negative thermal expansion, minimum temperature Tmin for negative thermal expansion, and maximum temperature Tmax for negative thermal expansion were measured. The linear thermal expansion of each ruthenium oxide was measured using a laser interference thermal dilatometer (LIX-2, from ULVAC, Inc.) within the temperature range of −183 to 227 degrees C.

The total volume variation ΔV/V, the linear expansion coefficient α, ΔT, Tmin, and Tmax were obtained from the measurement result of the linear thermal expansion. Each of the linear expansion coefficients α presented below is a representative value within a temperature range in which negative linear thermal expansion is exhibited.

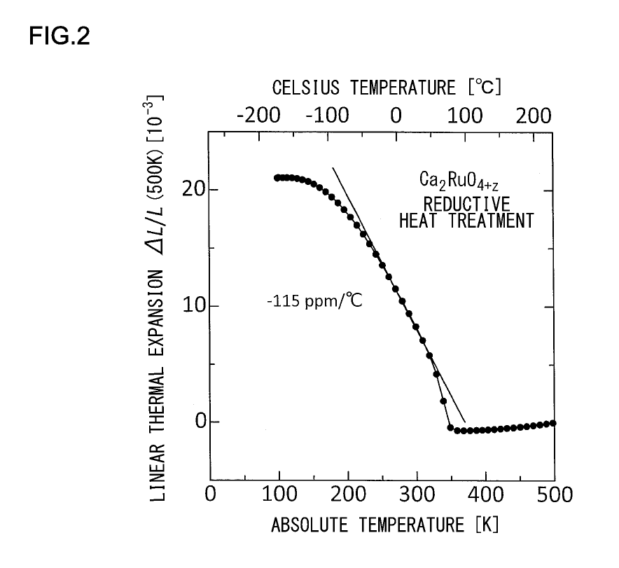

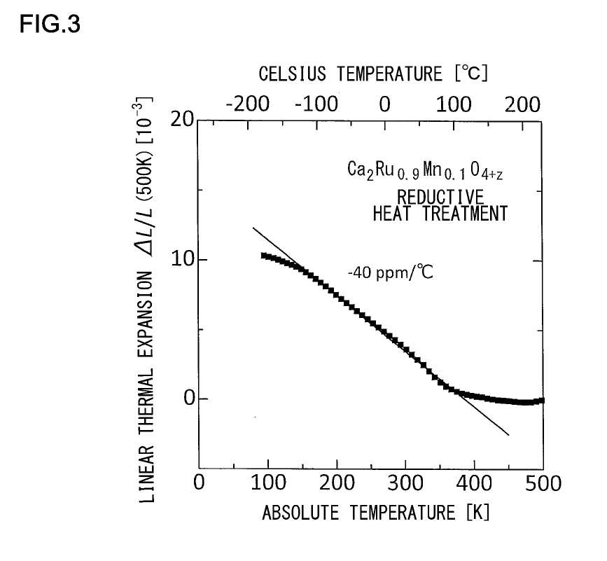

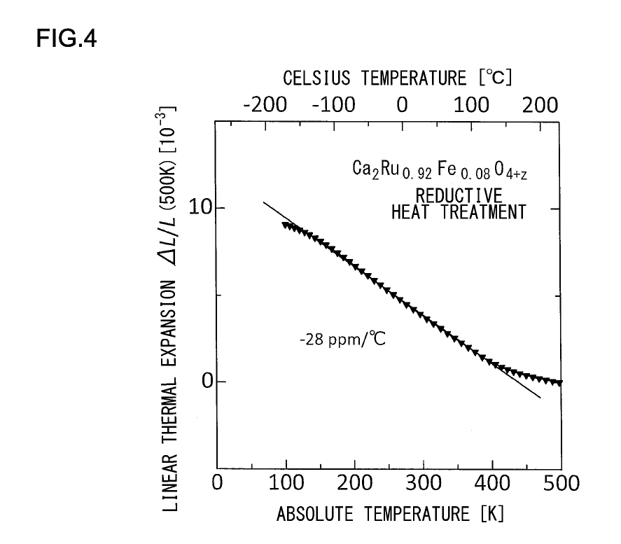

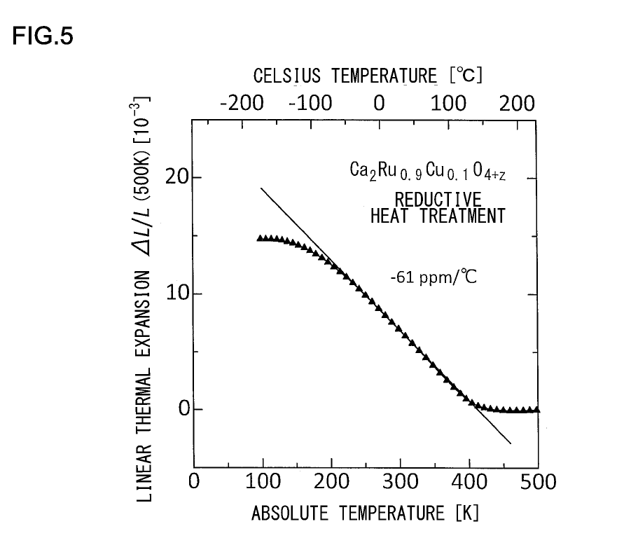

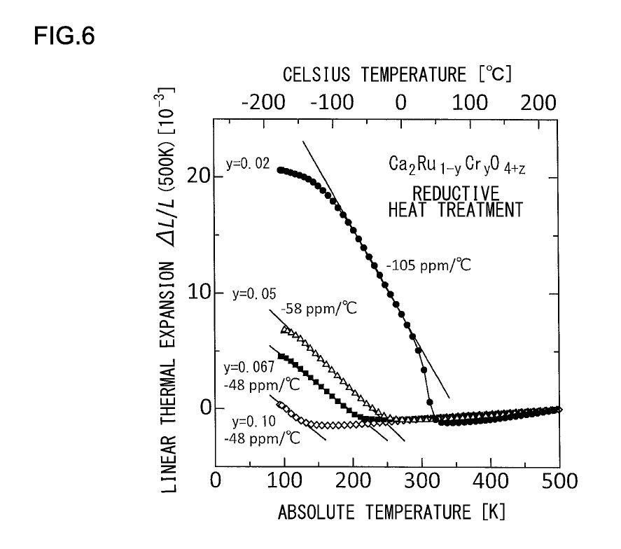

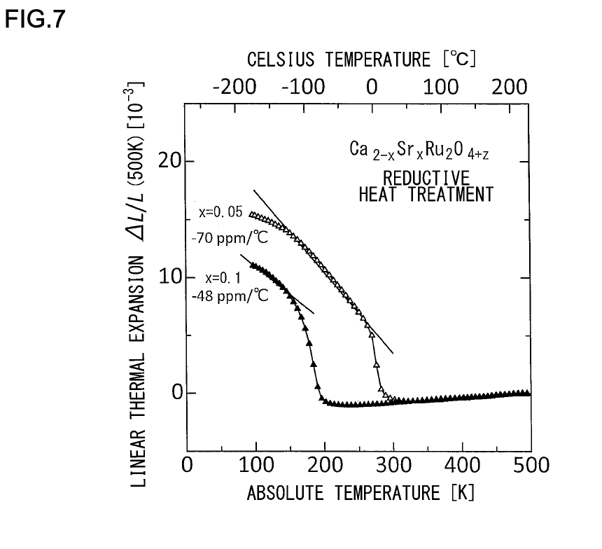

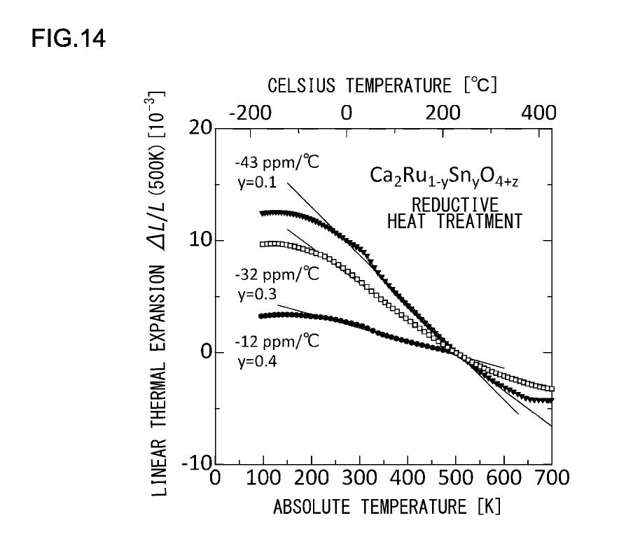

Table 1 below shows the measurement results. Also, FIGS. 2-7 and 14 are graphs that each show the linear thermal expansion of a specimen in the Example. The values of linear thermal expansion were derived based on 500 K. In Table 1, each numeral shown in the column “Figure” designates a corresponding linear thermal expansion graph among FIGS. 2-7 and 14. FIG. 2 shows relationships between temperature and linear thermal expansion of a specimen represented by the general formula Ca₂RuO_{4+z}. FIG. 3 shows relationships between temperature and linear thermal expansion of a specimen represented by the formula Ca₂RuO_{0.9}Mn_{0.1}O_{4+z}. FIG. 4 shows relationships between temperature and linear thermal expansion of a specimen represented by the formula Ca₂Ru_{0.92}Fe_{0.08}O_{4+z}. FIG. 5 shows relationships between temperature and linear thermal expansion of a specimen represented by the formula Ca₂Ru_{0.9}Cu_{0.1}O_{4+z}. FIG. 6 shows relationships between temperature and linear thermal expansion of specimens represented by the general formula Ca₂Ru_{1-y}Cr_{y}O_{4+z} with the value y changed (y=0.02, 0.05, 0.067, 0.1) FIG. 7 shows relationships between temperature and linear thermal expansion of specimens represented by the general formula Ca₂₋ₓSrₓRuO_{4+z} with the value x changed (x=0.05, 0.1) FIG. 14 shows relationships between temperature and linear thermal expansion of specimens represented by the general formula Ca₂Ru_{1-y}Sn_{y}O_{4+z} with the value y changed (y=0.1, 0.3, 0.4).

For comparison, characteristic values of conventionally typical negative thermal expansion materials are shown in Table 2. With regard to each material having anisotropy in crystal system, an average value is presented as the linear expansion coefficient α in Table 2. The characteristic values shown in Table 2 were obtained with reference to the following references.

### REFERENCES

1 T. A. Mary et al., Science 272, 90-92 (1996).
2 A. E. Phillips et al., Angew. Chem. Int. Ed. 47, 1396-1399 (2008).
3 K. Takenaka and H. Takagi, Appl. Phys. Lett. 87, 261902 (2005).
4 J. Chen et al., Appl. Phys. Lett. 89, 101914 (2006).
5 I. Yamada et al., Angew. Chem. Int. Ed. 50, 6579-6582 (2011).
6 M. Azuma et al., Nature Commun. 2, 347 (2011).
7. J. Huang et al., J. Am. Chem. Soc. 135, 11469-11472 (2013).
8 Y. Y. Zhao et al., J. Am. Chem. Soc. 137, 1746-1749 (2015).

| | | | | | α | |
|---|---|---|---|---|---|---|
| | ΔV/V | Tmin | Tmax | ΔT | [ppm/° | |
| CHEMICAL FORMULA | [%] | [° C.] | [° C.] | [° C.] | C.] | FIG. |
| Ca₂RuO_{4+z} | 6.7 | −138 | 72 | 210 | −115 | 2 |
| Ca₂Ru_{0.9}Mn_{0.1}O_{4+z} | 3.1 | *−183 | 197 | 380 | −40 | 3 |
| Ca₂Ru_{0.92}Fe_{0.08}O_{4+z} | 2.8 | *−183 | *227 | 410 | −28 | 4 |
| Ca₂Ru_{0.9}Cu_{0.1}O_{4+z} | 4.4 | −143 | 157 | 300 | −61 | 5 |
| Ca₂Ru_{0.98}Cr_{0.02} O_{4+z} | 6.5 | *−183 | 47 | 230 | −105 | 6 |
| Ca₂Ru_{0.95}Cr_{0.05}O_{4+z} | 2.3 | *−183 | −18 | 165 | −58 | 6 |
| Ca₂Ru_{0.933}Cr_{0.067}O_{4+z} | 1.6 | *−183 | −63 | 120 | −48 | 6 |
| Ca₂Ru_{0.9}Cr_{0.1}O_{4+z} | 0.5 | *−183 | −133 | 50 | −48 | 6 |
| Ca_{1.95}Sr_{0.05}RuO_{4+z} | 4.7 | *−183 | 17 | 200 | −70 | 7 |
| Ca_{1.9}Sr_{0.1}RuO_{4+z} | 3.5 | *−183 | −78 | 105 | −48 | 7 |
| Ca₂Ru_{0.9}Sn_{0.1}O_{4+z} | 4.8 | −123 | 392 | 515 | −43 | 14 |
| Ca₂Ru_{0.7}Sn_{0.3}O_{4+z} | 4.0 | −108 | *427 | 535 | −32 | 14 |
| Ca₂Ru_{0.6}Sn_{0.4}O_{4+z} | 1.0 | −70 | *227 | 297 | −12 | 14 |

of the measurement temperature; in fact, it can be easily assumed that negative thermal expansion would be still observed beyond the limits.

TABLE 2

| NEGATIVE THERMAL | | | | | | | |
|---|---|---|---|---|---|---|---|
| EXPANSION SUBSTANCE/ | ΔV/V | Tmin | Tmax | ΔT | α | CRYSTAL | |
| MATERIAL | [%] | [° C.] | [° C.] | [° C.] | [ppm/° C.] | SYSTEM | REFERENCE |
| ZrW₂O₈ | 1.2 | −273 | 152 | 425 | −9 | CUBIC | *1 |
| Cd(CN)₂ | 2.1 | −103 | 102 | 205 | −34 | CUBIC | *2 |
| Mn₃Ga_{0.7}Ge_{0.3}N_{0.88}C_{0.12} | 0.5 | −76 | 46 | 122 | −18 | CUBIC | *3 |
| 0.4PbTiO₃—0.6BiFeO₃ | 2.7 | 25 | 650 | 625 | −13 | TETRAGONAL | *4 |
| SrCu₃Fe₄O₁₂ | 0.4 | −93 | −23 | 70 | −20 | CUBIC | *5 |
| Bi_{0.95}La_{0.05}NiO₃ | 2.0 | 47 | 107 | 60 | −82 | TRICLINIC | *6 |
| LaFe_{10.5}Co_{1.0}Si_{1.5} | 1.1 | −33 | 77 | 110 | −26 | CUBIC | *7 |
| MnCo_{0.98}Cr_{0.02}Ge | 3.2 | −151 | 59 | 210 | −52 | RHOMBIC | *8 |

A comparison between Tables 1 and 2 shows that the total volume variations ΔV/V of the ruthenium oxides of the present disclosure are significantly larger than those of conventional negative thermal expansion materials. Also, the ruthenium oxides of the present disclosure have temperature ranges ΔT for negative thermal expansion equal to or wider than those of conventional negative thermal expansion materials, and have linear expansion coefficients α equal to or smaller than those of conventional negative thermal expansion materials. Thus, it can be said that the ruthenium oxides of the present disclosure exhibit larger degrees of negative thermal expansion compared to conventional negative thermal expansion materials and hence are highly available in industrial fields.

Table 1 and FIGS. 2-7 and 14 show that the total volume variation ΔV/V, the linear expansion coefficient α, ΔT, Tmin, and Tmax can be controlled by changing the R content x, the type of the element M, and the M content y in the general formula Ca₂₋ₓRₓRu_{1-y}M_{y}O_{4+z}. Also, FIGS. 3-5 show that, when M is Mn, Fe, or Cu, an increase in M content tends to lead to an increase in Tmax and an increase in linear expansion coefficient α (i.e., a decrease in absolute value of the negative value). Further, FIGS. 6 and 7 show that, when R is Sr or when M is Cr, an increase in R content x or M content y tends to lead to a decrease in Tmax and an increase in linear expansion coefficient α (i.e., a decrease in absolute value of the negative value). With regard to the total volume variation ΔV/V, ΔT, and Tmin, it is surmised that those factors probably tend to decrease when the M content y increases, though such surmise is made for a range beyond the measurement range and hence is unclear.

### (3) Evaluation of Reductive Heat Treatment

In order to ascertain that the reductive heat treatment contributes to large negative thermal expansion in the present disclosure, the following experiments were conducted.

As Comparative Example 1, a ruthenium oxide Ca₂RuO_{4+z} was prepared by the following method. First, according to the method using the reductive heat treatment as described in “(1) Preparation of Ruthenium Oxides” above, a ruthenium oxide Ca₂RuO_{4+z}(hereinafter, referred to as the “ruthenium oxide of Example 1-1”) was obtained. The sintered product thus obtained in the reductive heat treatment was then further heated in an atmosphere of oxygen at 4 to 5 atmospheres, at a temperature in the range of 500 to 550 degrees C. for 40 to 60 hours. Such treatment will be hereinafter referred to as “high-pressure oxygen treatment”. The ruthenium oxide thus obtained will be referred to as the ruthenium oxide of Comparative Example 1. As a result of linear thermal expansion measurement, the ruthenium oxide of Comparative Example 1 did not exhibit negative thermal expansion, or exhibited extremely restrained negative thermal expansion.

The ruthenium oxide Ca₂RuO_{4+z} of Comparative Example 1 subjected to the high-pressure oxygen treatment was then further heated in a stream of mixed gas containing 0.8 atmospheres of argon and 0.2 atmospheres of oxygen, at a temperature in the range of 1,250 to 1,370 degrees C. for 40 to 60 hours, thereby obtaining a ruthenium oxide. The ruthenium oxide thus obtained will be referred to as the ruthenium oxide of Example 1-2.

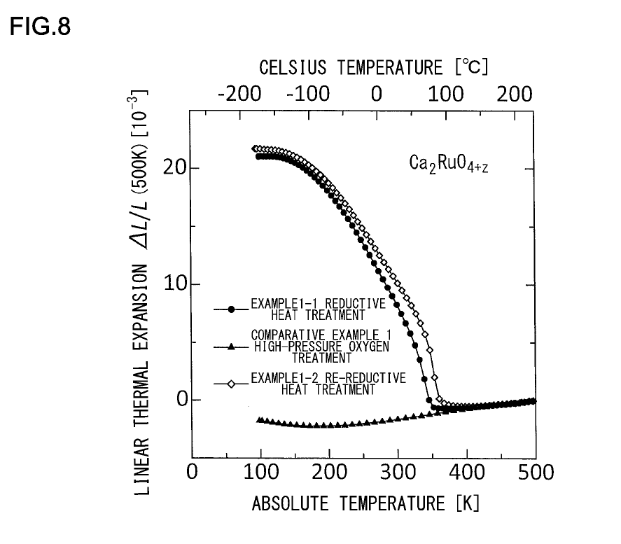

FIG. 8 shows relationships between temperature and linear thermal expansion of ruthenium oxides of Examples 1-1, 1-2, and Comparative Example 1. As shown in FIG. 8, it is found that, when the ruthenium oxide of the Example 1-1, which has exhibited large negative thermal expansion after the reductive heat treatment, is subjected to the high-pressure oxygen treatment, such large negative thermal expansion is significantly restrained. It is also found that, when the ruthenium oxide of Comparative Example 1, which has not exhibited large negative thermal expansion after the high-pressure oxygen treatment, is subjected again to the reductive heat treatment, large negative thermal expansion as exhibited before the high-pressure oxygen treatment can be restored. As a result, it is found that the reductive heat treatment is essential for large negative thermal expansion of the ruthenium oxides.

### (4) Evaluation of Oxygen Content z

It has been reported that, with regard to the oxygen content in a ruthenium oxide Ca₂Ru_{1-y}M_{y}O_{4+z}, the value z satisfies −0.01(1)≤z≤0.07(1), i.e., −0.02≤z≤0.08 with maximal consideration of errors (Non-patent Document 2). The ruthenium oxide subjected to the high-pressure oxygen treatment in Comparative Example 1 can be regarded as sufficiently containing oxygen, and z is nearly 0.07. Using an electronic precision balance (XP56, from METTLER TOLEDO), it was ascertained that the specimen weight was increased by 1-2% through the high-pressure oxygen treatment described above. This weight variation corresponds to an increase by 0.15-0.30 in terms of z. Accordingly, it is considered that z of a ruthenium oxide of Examples 1 is in the range of −0.23 to −0.08, which means that the ruthenium oxide is a substance of which the oxygen content z is in a publicly-unknown range. It has been reported that “oxygen excess (z>0) can be achieved, but oxygen deficiency (z<0) is not easy to achieve” {F. Nakamura, et al., Sci. Rep. 3, 2536 (2013), for example}, which has been general recognition before the filing of the subject application. In general, evaluating the oxygen contents in oxides is technically difficult, and it is to be considered that an obtained value may include an experimental error. Therefore, it is noted that the measured values described above may include experimental errors.

### Example 2

Using powders of CaCO₂, RuO₂, and SnO₂ as materials, a ruthenium oxide represented by Ca₂Ru_{1-y}Sn_{y}O_{4+z} was obtained by a solid-phase reaction method. First, the material powders were weighed out such that the mole ratio of Ca:Ru:Sn became 2:1-y:y and agitated, and the resultant mixture was then heated and calcined in the air or in a stream of mixed gas containing 0.8 atmospheres of argon and 0.2 atmospheres of oxygen, at a temperature in the range of 1,000 to 1,100 degrees C. for 12 to 24 hours.

The resultant powder was agitated and packed into a tablet form, and then heated and calcined in a stream of mixed gas containing 0.8 atmospheres of argon and 0.2 atmospheres of oxygen, at a temperature in the range of 1,250 to 1,370 degrees C. for 40 to 60 hours to be sintered, thereby obtaining a ruthenium oxide represented by the general formula Ca₂Ru_{1-y}Sn_{y}O_{4+z}.

With regard to each ruthenium oxide represented by the general formula Ca₂Ru_{1-y}Sn_{y}O_{4+z} thus obtained, the linear thermal expansion was measured in the same way as in Examples 1, and the total volume variation ΔV/V, the linear expansion coefficient α, ΔT, Tmin, and Tmax were obtained from the measurement result. In part of the linear thermal expansion measurement, the upper limit of the measurement temperature was raised to 427 degrees C.

The measurement results of the ruthenium oxides of Example 2 are also shown in Table 1 previously given in Examples 1. The eleventh to thirteenth chemical formulae in Table 1 are the ruthenium oxides of Example 2. The meaning of the mark * in Table 1 is the same as described previously, i.e., each value of Tmin and Tmax marked with * in Table 1 means that negative thermal expansion was observed even at the lower limit (−183 degrees C.) or the upper limit (427 degrees C.) of the measurement temperature; in fact, it can be easily assumed that negative thermal expansion would be still observed beyond the limits. FIG. 14 is a graph of linear thermal expansion. Table 1 and FIG. 14 show that, as with the ruthenium oxides of Examples 1, the ruthenium oxides of Example 2 also show the total volume variations ΔV/V significantly larger than those of conventional negative thermal expansion materials. Also, the ruthenium oxides of Example 2 have temperature ranges ΔT for negative thermal expansion equal to or wider than those of conventional negative thermal expansion materials, and have linear expansion coefficients α equal to or smaller than those of conventional negative thermal expansion materials. Thus, it can be said that the ruthenium oxides of Example 2 also exhibit larger degrees of negative thermal expansion compared to conventional negative thermal expansion materials.

Particularly, it is found that replacing part of Ru sites with Sn can significantly widen the temperature range ΔT for negative thermal expansion and can also significantly raise the maximum temperature Tmax for negative thermal expansion. For example, when the Sn content y is 0.3, ΔT is 535 degrees C. and Tmax is at least 427 degrees C.; thus, the temperature range for negative thermal expansion can be extended to a high-temperature range. This is greatly meaningful in terms of industrial applications.

Also, Table 1 and FIG. 14 show that a larger Sn content y tends to lead to a larger linear thermal expansion coefficient (i.e., a smaller absolute value because the linear expansion coefficients are negative), a wider temperature range ΔT for negative thermal expansion, and a higher maximum temperature Tmax for negative thermal expansion. Accordingly, it is found that the linear expansion coefficient, ΔT, and Tmax can be controlled by changing the Sn content y.

As described above, since each ruthenium oxide of Example 2 obtained by replacing part of Ru sites with Sn and represented by the general formula Ca₂Ru_{1-y}Sn_{y}O_{4+z} has a wider temperature range ΔT for negative thermal expansion and a higher maximum temperature Tmax for negative thermal expansion, the ruthenium oxides of Example 2 are advantageous in terms of industrial applications, such as applications to thermal expansion inhibitors. Also, since Sn is less expensive than Ru, the ruthenium oxides also have a great industrial advantage of reduced material cost.

### [Composite Materials]

The inventors and others have focused attention on the abovementioned ruthenium oxides as materials that exhibit negative thermal expansion, and have conducted various studies. Also, the inventors and others have conceived that a composite material formed by combining such a ruthenium oxide and a resin would be a material of which thermal expansion can be restrained, which is difficult with the resin alone. In the following, methods for producing composite materials and the properties of the produced composite materials will be described. The ruthenium oxides to be included in resins to form composite materials include not only the ruthenium oxides described in the aforementioned Examples but also ruthenium oxides obtained by adjusting the composition ratio of each element within a predetermined range or replacing part of elements with other elements in the ruthenium oxides represented by the general formulae.

### (1) Method for Producing Epoxy Composite Materials

First, a ruthenium oxide with the formula Ca₂Ru_{0.92}Fe_{0.08}O_{3.82} was prepared as a filler. The filler and liquid epoxy resin was weighed out and mixed together in a mold made of fluororesin. The mold was connected to a motor, which was slowly rotated at 11 rpm, so that a mixture was prepared. The mixture specimen was then slowly polymerized at an ambient temperature of 50 degrees C. over 24 hours such that the viscosity of the mixture would not become too low. Thereafter, the resin in the mixture specimen was hardened at an ambient temperature of 150 degrees C. over an hour, thereby preparing a composite material specimen that includes a resin matrix phase, and a ruthenium oxide having Ca₂RuO₄ structure and included in the resin matrix phase. With regard to the prepared composite material specimen, linear thermal expansion at a temperature T was measured by the aforementioned method. In the same way, composite material specimens that each include, as a filler, a ruthenium oxide with the formula Ca₂Ru_{0.9}MnO_{0.1}O_{3.73} or Ca₂RuO_{3.74}, composite material specimens that each include, as a filler, a ruthenium oxide with the formula Ca₂Ru_{0.9}CuO_{0.1}O_{3.82} or Ca₂Ru_{0.933}CuO_{0.067}O_{3.77}, and a composite material specimen that includes, as a filler, a ruthenium oxide with the formula Ca₂Ru_{0.9}Sn_{0.1}O₄ were prepared, and the linear thermal expansion of each of the composite material specimens was measured.

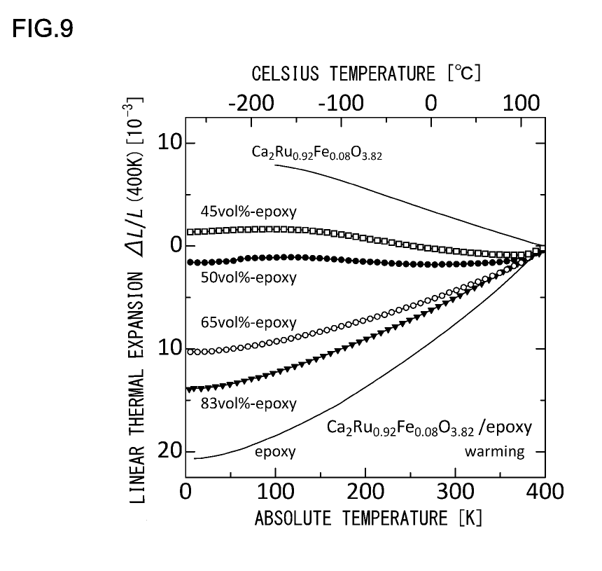

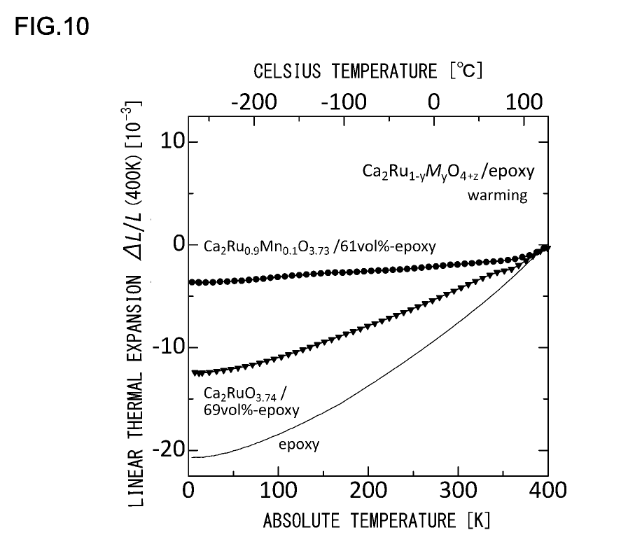

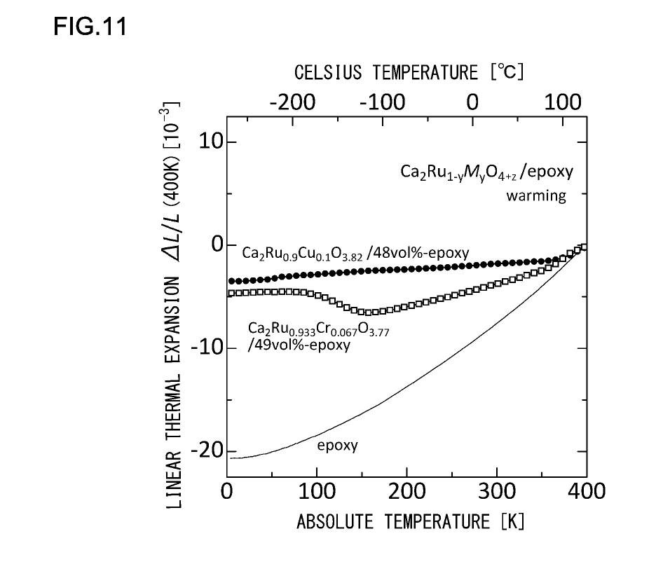

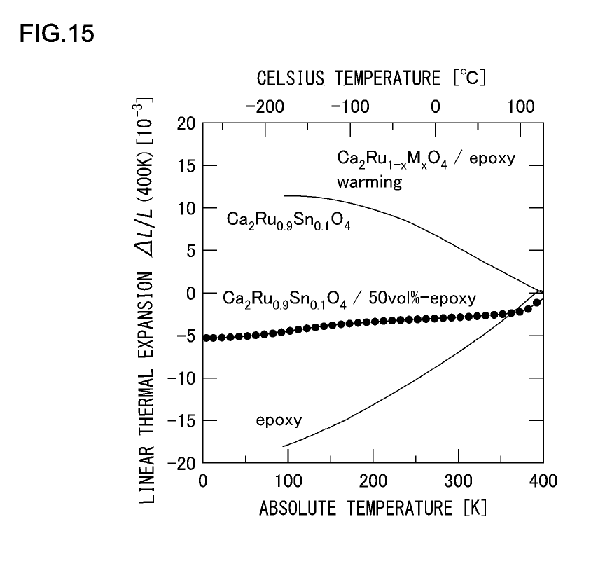

FIG. 9 shows relationships between temperature and linear thermal expansion of composite material specimens, each prepared by mixing a ruthenium oxide with the formula Ca₂Ru_{0.92}Fe_{0.08}O_{3.82} and a predetermined amount of an epoxy resin (0, 45, 50, 65, 83, or 100 vol %). FIG. 10 shows relationships between temperature and linear thermal expansion of composite material specimens, each prepared by mixing a ruthenium oxide with the formula Ca₂Ru_{0.9}Mn_{0.1}O_{3.73} or Ca₂RuO_{3.74} and a predetermined amount of an epoxy resin (61 vol % or 69 vol %). FIG. 11 shows relationships between temperature and linear thermal expansion of composite material specimens, each prepared by mixing a ruthenium oxide with the formula Ca₂Ru_{0.9}Cu_{0.1}O_{3.82} or Ca₂Ru_{0.933}Cu_{0.067}O_{3.77} and a predetermined amount of an epoxy resin (48 vol % or 49 vol %). FIG. 15 shows relationships between temperature and linear thermal expansion of a composite material specimen prepared by mixing a ruthenium oxide with the formula Ca₂Ru_{0.9}Sn_{0.1}O₄ and a predetermined amount of an epoxy resin (50 vol %).

As shown in FIGS. 9-11 and 15, it is found that each composite material including a ruthenium oxide as a filler and an epoxy resin matrix phase exhibits restrained thermal expansion, in comparison with the large positive linear expansion coefficient of the epoxy resin alone. Also, a composite material having a desired linear expansion coefficient within the range between the linear expansion coefficient of the ruthenium oxide alone and the linear expansion coefficient of the epoxy resin alone can be easily prepared.

### (2) Method for Producing Polyvinyl Butyral (PVB) and Polyamide-Imide (PAI) Composite Materials

First, a ruthenium oxide with the formula Ca₂RuO_{3.74} or Ca₂Ru_{0.92}Fe_{0.8}O_{3.82} was prepared as a filler. The filler and a PVB or PAI powder were weighed out and mixed together in a mortar, so that a mixture specimen was prepared. The mixture specimen was pelletized using a mold and then calcined in the air for 3 hours, at 150 degrees C. for the PVB specimen and at 300 degrees C. for the PAI specimen, thereby preparing a resin composite material specimen including a ruthenium oxide. With regard to the prepared composite material specimen, linear thermal expansion at a temperature T was measured by the aforementioned method.

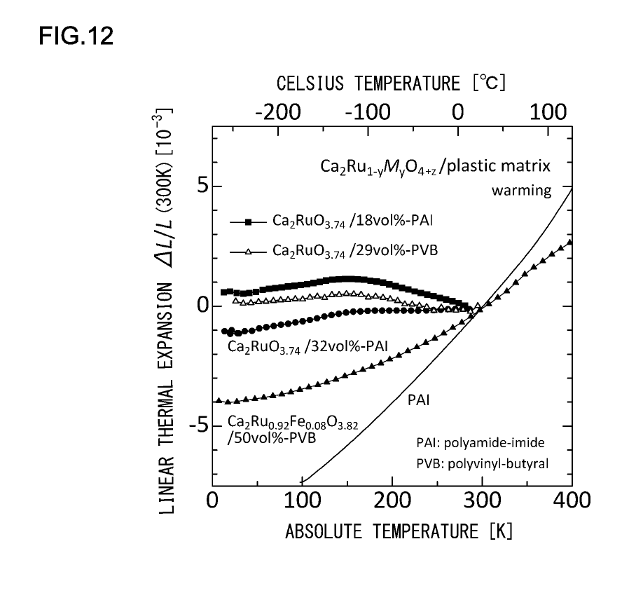

FIG. 12 shows relationships between temperature and linear thermal expansion of composite material specimens, each prepared by mixing a ruthenium oxide with the formula Ca₂RuO_{3.74} or Ca₂Ru_{0.92}Fe_{0.08}O_{3.82} and a predetermined amount of PVB resin (29 vol % or 50 vol %) or a predetermined amount of a PAI resin (18 vol % or 32 vol %).

As shown in FIG. 12, it is found that each composite material including a ruthenium oxide as a filler and a PVB or PAI resin matrix phase exhibits restrained thermal expansion, in comparison with the large positive linear expansion coefficient of the PAI resin, for example. Also, based on the results shown in FIG. 12, the PVB resin content in the composite material may be within the range of 29 vol % to 50 vol %. Similarly, the PAI resin content in the composite material may be within the range of 18 vol % to 32 vol %. Based on the results, a person skilled in the art would naturally conceive that similar effects could also be obtained by using other engineering plastics or thermoplastic resins, instead of the PAI resin.

### (3) Method for Producing Phenolic Composite Materials

First, a ruthenium oxide with the formula Ca₂Ru_{0.92}Fe_{0.08}O_{3.82} was prepared as a filler. The filler and a phenolic resin powder were weighed out and mixed together in a mortar, so that a mixture specimen was prepared. The mixture specimen was placed in a mold and then heated at an ambient temperature of 150 degrees C. for 10 minutes, with pressure of about 250 MPa applied thereto using Rapid press (MPB-323, from Refine Tec Ltd.), such as to be polymerized and hardened, thereby preparing a composite material specimen. With regard to the prepared composite material specimen, linear thermal expansion at a temperature T was measured by the aforementioned method.

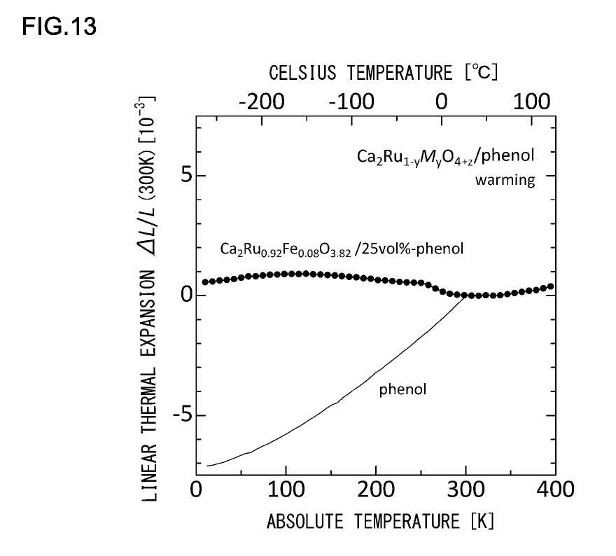

FIG. 13 shows relationships between temperature and linear thermal expansion of a composite material specimen prepared by mixing a ruthenium oxide with the formula Ca₂Ru_{0.92}Fe_{0.8}O_{3.82} and a predetermined amount of a phenolic resin (25 vol %).

As shown in FIG. 13, it is found that a composite material including a ruthenium oxide as a filler and a phenolic resin matrix phase exhibits restrained thermal expansion, in comparison with the large positive linear expansion coefficient of the phenolic resin, for example. Based on the results, a person skilled in the art would naturally conceive that similar effects could also be obtained by using other thermosetting resins, instead of the epoxy resin or phenolic resin.

### (4) Method for Producing Metallic Composite Materials

First, a ruthenium oxide with the formula Ca₂Ru_{0.9}Sn_{0.1}O₄ was prepared as a filler. Thereafter, the filler and an aluminum powder were weighed out and mixed together to be placed in a mold made of carbon. By spark plasma sintering, pulse current was applied to the mold while the mixture in the mold was pressurized at 40 MPa and heated at 375 degrees C. for 5 minutes. Thus, a composite material specimen formed of a sintered product was prepared. With regard to the prepared composite material specimen, linear thermal expansion at a temperature T was measured by the aforementioned method.

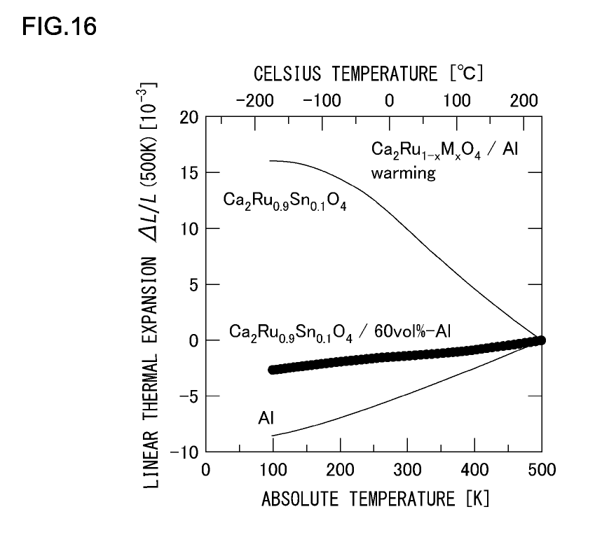

FIG. 16 shows relationships between temperature and linear thermal expansion of a composite material specimen prepared by mixing a ruthenium oxide with the formula Ca₂Ru_{0.9}Sn_{0.1}O₄ and a predetermined amount of aluminum (60 vol %).

As shown in FIG. 16, it is found that a composite material including a ruthenium oxide as a filler and an aluminum matrix phase exhibits restrained thermal expansion, in comparison with the large positive linear expansion coefficient of aluminum, for example. Based on the results, a person skilled in the art would naturally conceive that similar effects could also be obtained by using magnesium instead of aluminum.

As described above, the composite materials of the present disclosure provide revolutionary functions, such as restraining (or enabling almost zero) thermal expansion of a composite material in a wide temperature range of about 5 K (−269 degrees C.) to 400 K (127 degrees C.), by adjusting the mixing ratio of a ruthenium oxide and resin or the like. Accordingly, thermal expansion can be controlled in a wide operating temperature range, with a linear expansion coefficient in a wide range, while impairing of the functions of resin or the like as the base material (matrix phase) is retrained. Consequently, the operational stability and reliability of optical instruments can be improved, and the working accuracy of processing devices can also be improved, for example. Particularly, as the matrix phases of the composite materials of the present disclosure, resin materials or metal materials with linear expansion coefficients of 2×10⁻⁵/degree C. or greater can also be employed; therefore, the application can be extended, for example, to resins or the likes, which have not been employed in terms of thermal expansion while they have excellent mechanical properties or chemical properties.

1. A composite material, comprising:
a resin matrix phase; and
a sintered product of a ruthenium oxide that has Ca₂RuO₄ structure and exhibits negative thermal expansion, the sintered product being included in the resin matrix phase.

2. The composite material of claim 1, wherein the resin matrix phase includes, as a material, one of epoxy resins, engineering plastics, polyvinyl butyral resin, and phenolic resins.

3. The composite material of claim 1, wherein the resin matrix phase includes a resin material having a linear expansion coefficient of 2×10⁻⁵/degree C. or greater.

4. (canceled)

5. (canceled)

6. (canceled)

7. (canceled)

8. The composite material of claim 1 wherein the ruthenium oxide exhibits negative thermal expansion in a predetermined temperature range and is represented by a general formula (3):
Ca₂RuO_{4+z}
wherein the value z satisfies −1<z<1.

9. The composite material of claim 1, wherein the ruthenium oxide exhibits negative thermal expansion throughout the range of a temperature Tmin to a temperature Tmax (Tmin<Tmax), and a total volume variation ΔV/V, which is an increase rate of the volume at the temperature Tmin based on the volume at the temperature Tmax, is larger than 1%.

10. The composite material of claim 1, wherein the ruthenium oxide has a linear expansion coefficient of −20×10⁻⁶/degree C. or less.

11. The composite material of claim 1, wherein the ruthenium oxide exhibits negative thermal expansion throughout a temperature range having a width of 100 degrees C. or more.

12. The composite material of claim 1, wherein the ruthenium oxide has a layered perovskite crystal structure.

13. A composite material, comprising:
a matrix phase made of a material that exhibits positive thermal expansion; and
a ruthenium oxide having Ca₂RuO₄ structure and included in the matrix phase, wherein
part of Ru sites are replaced with Sn in the ruthenium oxide.

14. The composite material of claim 13, wherein the matrix phase includes, as a material, one of epoxy resins, engineering plastics, polyvinyl butyral resin, phenolic resins, aluminum, and magnesium.

15. The composite material of claim 13, wherein the matrix phase includes a resin material having a linear expansion coefficient of 2×10⁻⁵/degree C. or greater.

16. The composite material of claim 13, wherein the ruthenium oxide is represented by a general formula (1):
Ca₂₋ₓRₓRu_{1-y1-y2}Sn_{y}M_{y2}O_{4+z}
wherein R represents at least one element selected from among alkaline earth metals and rare earth elements; M represents at least one element selected from among Sc, Ti, V, Cr, Mn, Fe, Co, Ni, Cu, Zn, Ga, Y, Zr, Nb, Mo, Tc, Ru, Rh, Pd, Ag, Cd, and In; and the values x, y1, y2, and z satisfy 0≤x<0.2, 0<y1<0.5, 0≤y2≤0.2, 0<y1+y2≤0.6, and −1<z<1.

17. The composite material of claim 13, wherein
the ruthenium oxide is represented by a general formula (2):
Ca₂₋ₓRₓRu_{1-y1-y2}Sn_{y1}M_{y2}O_{4+z}
wherein R represents at least one element selected from among alkaline earth metals and rare earth elements; M represents at least one element selected from among Sc, Ti, V, Cr, Mn, Fe, Co, Ni, Cu, Zn, Ga, Y, Zr, Nb, Mo, Tc, Ru, Rh, Pd, Ag, Cd, and In; and the values x, y1, y2, and z satisfy 0≤x<0.2, 0<y1<0.5, 0≤y2≤0.2, 0<y1+y2≤0.6, and −1<z<1, and
the ruthenium oxide exhibits negative thermal expansion throughout the range of a temperature Tmin to a temperature Tmax (Tmin<Tmax), and a total volume variation ΔV/V, which is an increase rate of the volume at the temperature Tmin based on the volume at the temperature Tmax, is larger than 1%.

18. (canceled)

19. (canceled)

20. The composite material of claim 13, wherein the ruthenium oxide exhibits negative thermal expansion in a predetermined temperature range and is represented by a general formula (3):
Ca₂RuO_{4+z}
wherein the value z satisfies −1<z<1.

21. The composite material of claim 13, wherein the ruthenium oxide exhibits negative thermal expansion throughout the range of a temperature Tmin to a temperature Tmax (Tmin<Tmax), and a total volume variation ΔV/V, which is an increase rate of the volume at the temperature Tmin based on the volume at the temperature Tmax, is larger than 1%.

22. The composite material of claim 13, wherein the ruthenium oxide has a linear expansion coefficient of −20×10⁻⁶/degree C. or less.

23. The composite material of claim 13, wherein the ruthenium oxide exhibits negative thermal expansion throughout a temperature range having a width of 100 degrees C. or more

24. The composite material of claim 13, wherein the ruthenium oxide has a layered perovskite crystal structure.

25. A composite material, comprising:
a resin matrix phase; and
a sintered product of a ruthenium oxide that has Ca₂RuO₄ structure and exhibits negative thermal expansion, the sintered product being included in the resin matrix phase, wherein
the ruthenium oxide has a linear expansion coefficient of −20×10⁻⁶/degree C. or less.

26. The composite material of claim 8, wherein the ruthenium oxide exhibits negative thermal expansion throughout the range of a temperature Tmin to a temperature Tmax (Tmin<Tmax), and a total volume variation ΔV/V, which is an increase rate of the volume at the temperature Tmin based on the volume at the temperature Tmax, is larger than 1%.
